(19) United States
(12) Patent Application Publication
(10) Pub. No.: US 2025/0029499 A1
(43) Pub. Date: Jan. 23, 2025

(54) UNMANNED AIRCRAFT (UAS) DETECTION, RANGING AND COCKPIT DISPLAY SYSTEM ENHANCING SAFETY AND SITUATIONAL AWARENESS OF UAS TRAFFIC IN MANNED AND UNMANNED AIRCRAFT USING REMOTE IDENTIFICATION (RID) TECHNIQUES

(71) Applicant: RUMFERT, LLC, Omaha, NE (US)

(72) Inventor: David D. Jensen, Omaha, NE (US)

(73) Assignee: RUMFERT, LLC, Omaha, NE (US)

(21) Appl. No.: 18/776,967

(22) Filed: Jul. 18, 2024

Related U.S. Application Data
(60) Provisional application No. 63/527,737, filed on Jul. 19, 2023.
(60) Provisional application No. 63/547,175, filed on Nov. 3, 2023.

(51) Int. Cl. G08G 5/00; G08G 5/04

(52) U.S. Cl. CPC G08G 5/0021; G08G 5/0008; G08G 5/0013; G08G 5/04

(57) ABSTRACT

The invention discloses a system and method of displaying UAS traffic in the cockpits of manned aircraft and also for use with other unmanned aircraft. The invention utilizes the FAA concept of remote identification for supplying the UAS data necessary to generate traffic reports. The invention discloses several different methods of communicating the UAS remote ID data to re-broadcast stations which would then re-broadcast the UAS traffic reports to receiving aircraft. The invention suggests leveraging the existing ASD-B and TIS-B FAA traffic reporting system to communicate the UAS traffic reports to the receiving aircraft.

### CROSS REFERENCE TO RELATED APPLICATIONS

This application claims priority benefit of U.S. provisional applications Ser. Nos. 63/527,737 filed Jul. 19, 2023 and 63/547,175 filed Nov. 3, 2023 each of which is herein incorporated by reference in their entirety. This application references information disclosed in U.S. non-provisional application Ser. No. 17/565,121 filed Dec. 29, 2021; U.S. provisional applications Ser. Nos. 63/131,874 filed Dec. 30, 2020; 63/145,357 filed Feb. 3, 2021;63/173,100 filed Apr. 9, 2021; 63/234,131 filed Aug. 17, 2021, provisional application Ser. Nos. 62/868,905 filed Jun. 29, 2019; 62/990,660 filed Mar. 17, 2020; and non-provisional application Ser. No. 16/914,315 (now U.S. Pat. No. 11,837,100, filed Jun. 27, 2020, all of which are herein incorporated by reference in their entirety. This application also references information disclosed in U.S. patent applications Ser. No. 15/995,314 filed Jun. 1, 2018 (now U.S. Pat. No. 10,736,154), and Ser. No. 16/983,633 filed Aug. 3, 2020, (now U.S. Pat. No. 11,867,529), both of which are continuation-in-part applications of U.S. patent application Ser. No. 15/622,028 filed Jun. 13, 2017 (now U.S. Pat. No. 10,401,166), all of which are incorporated herein by reference in their entirety.

### TECHNICAL FIELD

The subject matter of the invention relates generally to the detection, identification, reporting, and display of unmanned aircraft (UAS) traffic to manned (or other unmanned) aircraft using remote identification data (RID) or other similar data, and a cockpit receiver/display system (CRDS). The UAS RID data includes parameters such as position and altitude which can be used to plot as traffic relative to the manned receiving aircraft. In this specification, ‘traffic’ is used to refer to manned or unmanned aircraft in the vicinity of an aircraft receiving the traffic reports. In an exemplary embodiment the UAS RID broadcast is direct to the receiving aircraft. In another exemplary embodiment, the UAS RID data is received in the receiving aircraft via a re-broadcast of the RID data by rebroadcast stations. Such broadcast stations might be either ground or air/space based. Examples of existing ground based stations might be the FAA's Traffic Information Service-Broadcast (TIS-B) and Automatic Dependant Surveillance-Broadcast (ADS-B) broadcast stations. In these latter embodiments, the receiving aircraft may utilize existing aircraft receivers for receiving the TIS-B or ADS-B rebroadcast of the UAS RID data as described below. In this specification, ‘receiving aircraft’ will be used to refer to aircraft, manned or unmanned, receiving UAS position/traffic reports and ‘re-broadcast station’ will refer to stations, ground or air, which re-broadcast the UAS RID signals to the receiving aircraft by processes described below.

In one exemplary embodiment, the UAS RID signal is received by a ground station in RF proximity to the UAS and is then rebroadcast to airborne aircraft giving the UAS RID signal a greater reception footprint than would be had with direct broadcast. In another exemplary embodiment, the UAS signal would be received by an airborne station, such as a satellite, and then rebroadcast. The greater reception footprint could be due to a greater transmission power of the ground or airborne re-broadcast station and perhaps its closer geographic proximity to the receiving aircraft. As mentioned, ‘receiving aircraft’ is used to refer to the aircraft receiving the UAS RID re-broadcast.

In another exemplary embodiment, the system and method utilize portions of the FAA's existing systems for disseminating manned aircraft traffic data to pilots such as the TIS-B or ADS-B broadcast systems. The UAS traffic may be displayed on a panel mount display used for the display of other traffic such as that used by avionics manufacturers to display traffic from an ADS-B system, Mode-S (TIS-B), or direct transponder interrogation. Additionally, portable devices such as a smartphone, laptop, tablet or any other device capable of displaying the FAA's TIS-B broadcast may be used. The display of UAS data may be of individual UAs or may be aggregated for display if there is a large number in a small area. Filters may be used to avoid saturation or distraction by filtering out UAS operating below a certain altitude, or within a certain distance of an airport, or other such parameter. In addition, UAS broadcasts of remote ID data using satellite and LTE/cellular are discussed. As mentioned, the term ‘remote identification’ is used to represent the transmission of certain navigational and identifying data from the UAS. While the FAA currently uses the term ‘Remote Identification’ to mean the transmission of several specific items using WiFi or Bluetooth protocols, the usage of that term in this specification will be broader encompassing similar, but also perhaps larger, data sets and also including additional transmission protocols beyond WiFi and BT4/BT5.

Manned aircraft operators have a vested interest in determining the position of UAS operating in their vicinity. This is especially true when the manned aircraft are making approach into, or departure from, airports. Conversely, manned aircraft owners are very much against the levying of additional expensive equipment requirements, such as additional receivers and displays, by the FAA. Thus, it is a primary objective of one implementation of the invention, to provide a means for displaying UAS traffic data to the pilots of manned aircraft without the need for introducing additional equipment requirements on the aircraft operator. In this embodiment, this is accomplished by using existing techniques for conveying and displaying manned traffic to pilots, e.g. TIS-B, ADS-B.

Currently, aircraft traffic advisory information for manned aircraft is available to pilots from the FAA's Traffic Information Service-Broadcast (TIS-B). TIS-B is a service broadcast by the FAA using the Mode S transponder system carried by almost all aircraft. The TIS-B system relies on the airport surveillance RADAR installed at airports to interrogate the transponders of aircraft. The position of the aircraft is computed based on range (D_{RADAR}) and azimuth (θ_{RADAR}) RADAR data and the altitude provided by the transponder. This position/altitude information is then placed into an ADS-B formatted message and transmitted as an ADS-B target to all aircraft equipped with TIS-B receivers.

In one exemplary embodiment, the present invention proposes that the FAA ground stations broadcasting the TIS-B targets be modified to add the capability of listening to the UAS remote ID broadcast data and then processing and formatting that data into ADS-B (TIS-B) traffic messages as is currently done for certain manned aircraft using RADAR and transponder data. The UAS remote ID broadcasts would provide the data necessary (L/L, speed, altitude) necessary for an ADS-B (TIS-B) traffic report. Note: It has been proposed that the TIS-B system be decommissioned in favor of the ADS-B system as the number of non-ADS-B aircraft has diminished. This invention proposes that the TIS-B system, or portions thereof, be retained and modified for the purpose of broadcasting the UAS data to pilots. The invention proposes that the FAA ground station be modified to receive, process, and format the UAS RID position data into ADS-B (out) messages for broadcast. (Guidelines/standards/requirements for ADS-B including message formats, are contained in RTCA docs 242A, 260A/B (ES), 282A/B (UAT) and 14 CFR 91.227.) When implemented, manned aircraft with ADS-B (In) functionality would be able to receive and display these UAS targets using their existing equipment. Modifications to the FAA ground station would include receiver facilities to receive the transmitted UAS RID data and software modification to read, decode, format and transmit the UAS RID data as UAS traffic data on the ADS-B or TIS-B systems. The payback for this investment is an increase in safety provided by the additional situational awareness of the UAS traffic. Of course the first step is to get the UAS data to the FAA ground station.

Depending on a variety of implementation details such as transmission protocol, transmit power, the range from the station, and the like, a variety of techniques may be used. For the FAA's remote ID rule (14 CFR § 89) WiFi Beacon and Bluetooth 5 extended advertising are the approved transmission protocols (see ASTM-F3586-22). However, although the scope of the present invention includes these protocols, it also includes numerous others such as LTE/cellular and satellite. Thus, several implementations are envisioned, differentiated by the communication protocol and the path the signal takes from the UAS to the receiving aircraft. It should be noted that the various implementations are not mutually exclusive and may be employed in various combinations. It is also understood that the particulars of the RF interfaces may change with changing technology and changing regulations while still implementing the design objectives of the invention.

Some implementation examples are:
A. ‘RF direct’—UAS transmits RID signal directly to the FAA ground station which then formats and re-broadcasts the UAS traffic reports to manned aircraft (see FIG. 1) (a sub category of the RF direct implementation is RF direct from the UAS to the receiving aircraft);
B. ‘RF relay’—the UAS transmits its remote ID signal to a ground based receiver relay station which then relays it to an FAA ground station via ground or RF relay and which then formats and re-broadcasts the UAS traffic reports to manned aircraft (see FIG. 2);
C. V/UHF/LTE/internet—the UAS transmits its remote ID data via cellular signal to a ground based cellular station connected to a ground network (e.g. internet) to which the FAA ground station may connect and retrieve the UAS data which then formats and re-broadcasts the UAS traffic reports to manned aircraft (see FIG. 3);
D. Satellite—the UAS transmits its remote ID signal to a satellite which then relays it to an FAA ground station, either directly (see FIG. 4), or via an additional satellite ground relay (see FIG. 5), which then formats and re-broadcasts the UAS traffic reports to manned aircraft.

As mentioned, the various methods are not mutually exclusive. For example the UAS might broadcast its remote ID data via WiFi or BT to satisfy the FAA requirements and broadcast using V/UHF, satellite, or LTE/cellular for UAS traffic awareness.

WiFi signals have a very limited range but the newest Bluetooth LE technology—Bluetooth 5 (BT5) with optimum receiver and transmitter technology can have a range in kilometers. If only this means of communication is used, it might be necessary to place several receiving stations around an airport to assure reception coverage.

Once the UAS RID data has been broadcast either directly or via one of the relay processes described above, the data must be received and processed so that it may be displayed in the receiving aircraft or otherwise utilized by other UAS. The receiving aircraft cockpit receiver/display system (CRDS) includes an RF receiver for receiving the RID data from in range UAS or from the re-broadcast stations described herein. The CRDS receiver is connected (via hardwire or RF (WiFi or Bluetooth) to a display device for display of the UAS data. The detector device may include a GPS for determining aircraft parameters (position, speed, altitude, track) so that relative position data such as ranging horizontal and vertically, closing speed and the like, may be displayed either pictorially or textually. The system may include an alerting feature in the nature of traffic collision avoidance. In the case where the re-broadcast station is an FAA TIS-B or ADS-B broadcast station, existing aircraft receivers/display may be used.

### BACKGROUND OF THE INVENTION

Although unmanned aircraft (UA) have been around for many years, advances in technology, introduction of quad rotors, and reductions in size and cost, have resulted in an escalation in recreational use and have begun to spur their exploitation for various commercial purposes. Exemplary commercial uses include package delivery, real estate surveys, and photography. Additionally, news organizations, law enforcement, commercial operators, and Department of Defense operations utilize UAS for various news and surveillance purposes.

With increasing numbers and uses of unmanned aircraft has come the need to better integrate these aircraft into the National Airspace System (NAS). In the United States, the Federal Aviation Administration (FAA) has been tasked with accomplishing this integration. As part of this effort, the FAA has promulgated various rules with one emphasis being the ability to remotely identify the UAS during flight. This identification requirement is known as remote identification or remote ID (RID).

In the United States, the Federal Aviation Administration (FAA) has mandated the use of remote identification technology for the vast majority of unmanned aircraft being operated in areas not designated an FAA recognized identification area (FRIA). The FAA has mandated WiFi and Bluetooth protocols be used to satisfy this new rule. One disadvantage of WiFi and Bluetooth are their relatively limited range.

V/UHF, LTE cellular and satellite communication protocols offer greater, and in some cases potentially world-wide, range but with the trade-off that more sophisticated receivers and/or additional infrastructure (e.g. ground relay receivers/stations, satellites etc required)

As mentioned, the communication modes are not mutually exclusive and the UAS RID broadcast module transmitting device might be constructed using configurable components, allowing it to utilize WiFi, BT, V/UHF RF, satellite, and LTE (cellular) communication technology individually or in various combinations (see US application 2022/0291677).

One limitation of the current environment is the lack of manned aircraft situational awareness of unmanned aircraft traffic. This creates a potential safety hazard regarding potential collisions. There is currently no requirement for equipment which would allow display of UAS traffic to pilots of manned aircraft. While the FAA has taken the baby step of identifying UAS traffic to ground observers with remote ID regulations, it is inevitable that as UAS traffic increases, a means for traffic awareness between manned and unmanned aircraft will be necessary, or even between unmanned aircraft. While the future need to display UAS traffic to manned aircraft seems inevitable, owners/operators of general aviation aircraft are particularly sensitive to rules requiring the purchase of additional equipment. Thus, it is a primary objective in one embodiment of the present invention, to provide a method for displaying UAS aircraft traffic in the cockpits of manned aircraft using existing aircraft equipment. Furthermore, since the FAA has deemed the use of ADS-B on UAS a non-starter due to frequency saturation concerns, the solution is not as simple as placing ADS-B (Out) transponders on UAS. Additionally, display saturation could be another potential issue with the display of UAS traffic, especially in the future when the number of UAS airborne at any one time is expected to increase dramatically. One way to address this concern might be an altitude or other filter which would only transmit UAS traffic messages for UAS above a certain height, within a certain radius of the airport, or other condition.

As mentioned above, a path currently exists for FAA ground stations to disseminate UAS traffic information to manned aircraft in a manner similar to what is currently being done between manned aircraft using the TIS-B and ADS-B (In) systems. However, instead of the RADAR as a source of position information, the UAS' transmission of remote ID data would provide the position information to the FAA ground station. Sufficient ground station geographic diversity would be required to accommodate the range of the UAS RID signal.

### SUMMARY OF THE INVENTION

The present invention is directed to a cockpit receiver/display system (CRDS) and method of receiving UAS RID broadcasts directly or through a ground/airborne re-broadcast process as described herein. The cockpit receiver/display system may be implemented with various display presentations to show the range and azimuth of UAS targets relative to the manned aircraft. Examples include a 2D plot as well as a more traditional RADAR type presentation (sometimes referred to as a plan position indicator) to graphically plot the position of the UAS relative to the manned aircraft. Indications of the relative vertical positions may also be provided along with alerts advising conditions where the UAS and manned aircraft are or may become too close. Textual presentation of data may also be available.

As mentioned, a primary objective of one embodiment of the invention is to provide a means for displaying UAS traffic data to pilots of manned aircraft without the need for introducing additional equipment requirements on aircraft owners/operators. To that end, an exemplary implementation of the invention proposes utilization of an existing traffic awareness interface for conveying and displaying manned aircraft targets to pilots, namely using the ADS-B (In) function similar to FAA's Traffic Information Service-Broadcast (TIS-B). In the case of the UAS traffic, the RADAR used for detection of manned aircraft traffic, would be replaced as the source of aircraft position with remote identification data broadcast by UAS.

The existing TIS-B system provides ADS-B (In) equipped aircraft with traffic surveillance information about manned aircraft which are not equipped with ADS-B (Out) systems ('non-participating aircraft'). The FAA TIS-B system relies on airport terminal RADAR and the aircraft's transponder. Specifically, the system relies on a position determination by RADAR and an altitude based on encoded altitude information (e.g. transponder interrogation). The position/altitude is then placed in an ADS-B formatted message and broadcast to all ADS-B (In) equipped aircraft. This same methodology may be largely reused for UAS traffic with a slight modification. Since smaller UAS are not typically equipped with transponder nor would they present a sufficient RAAR cross section for detection, they would not present suitable RADAR targets for the TIS-B system. However, the UAS remote ID system provides the position and altitude data inputs necessary for the TIS-B system to populate an ADS-B message. Thus a slight modification to the existing TIS-B system to listen for the UAS RID broadcast would allow for the re-broadcast of UAS positions to be used in TIS-B UAS traffic messages as is currently done for manned aircraft.

According to the teachings of an exemplary embodiment of the present invention, the UAS remote identification (Remote ID) transmitter would perform the function of broadcasting the UAS position and altitude to the FAA ground stations. A modification in the FAA ground station function would provide the station the ability to receive and process the UAS remote ID broadcast data. The UAS position data (L/L and alt) transmitted by the remote ID system would be received in the FAA ground station. At that point, the station has the data needed to format an ADS-B traffic message as is currently being done with the RADAR/transponder data for the non-participating aircraft manned aircraft. Obviously, data in addition to that required by the FAA for remote ID could be added to enhance the TIS-B/ADS-B (In) function such as heading, ground track, vertical speed and the like. As mentioned, in this specification, the term remote ID data shall be used to refer to the data currently required by the FAA as well as an expanded set of data which might be used for the TIS-B/ADS-B (In) function. Obviously ground station receivers would be required to provide sufficient reception coverage of the UAS RID signals. The payoff for this investment is the increase in safety provided by the enhanced situational awareness of the UAS traffic and the resulting avoidance of collisions.

As mentioned, one of the design goals of the invention is to utilize existing aircraft equipment. The UAS traffic broadcast using the modified TIS-B system could be displayed on the ADS-B aircraft cockpit displays manufactured by L3, Garmin, and many others, in a manner identical to that being used to display traffic today. Alternatively, a dedicated cockpit receiver/display system (CRDS) may have the display integrated with the ADS-B receiver, or the receiver and display may be connected wirelessly or by any number of wired connections.

### BRIEF DESCRIPTION OF THE DRAWINGS

FIG. 1 is a block diagram of the ‘RF direct’ implementation where the UAS transmits RID data via WiFi/BT/VUHF directly to the FAA ground station which is then packaged and broadcast to aircraft via the TIS-B/ADS-B (In) system.

FIG. 2 is a block diagram of the ‘RF relay’ implementation where the UA UAS transmits remote ID data via WiFi/BT/VUHF to a ground based receiver relay station which then relays it to an FAA ground station, via ground or RF relay, which then packages and broadcasts it to aircraft via the TIS-B/ADS-B (In) system.

FIG. 3 is a block diagram of the LTE/cellular/network implementation where the UAS transmits remote ID data via LTE/cellular signal to a ground based cellular station connected to a network such as the internet, which then relays it to an FAA ground station via the network which then packages and rebroadcasts it to aircraft via the TIS-B/ADS-B (In) system

FIG. 4 is a block diagram of the satellite implementation where the UAS transmits remote ID data to a satellite which then relays it to an FAA ground station directly, which then packages it and broadcasts it to aircraft via the TIS-B/ADS-B (In) system. This implementation relies on the FAA ground station having satellite receiving capabilities, if not, then the relay implementation of FIG. 5 may be used.

FIG. 5 is a block diagram of the satellite implementation where the UA transmits its remote ID data to a satellite which then transmits it to a satellite receiving ground station which is connected to a network such as the internet. The FAA ground station then receives the UAS data from the network and packages and broadcasts it to aircraft via the TIS-B/ADS-B (In) system.

FIGS. 6a-6d illustrate various implementations of the cockpit receiver/display system (CRDS).

FIGS. 7a-7c illustrate various presentation implementations of the cockpit display.

### DETAILED DESCRIPTION

The remote ID broadcast system (RBS) gathers UAS flight data during the conduct of a flight, and periodically transmits (i.e. broadcasts) the data. As described above, the purpose behind the FAA's remote ID mandate is to provide a means to identify an unmanned vehicle, specifically its owner and point of origin (take-off location). The intended audience for this information primarily is public safety individuals on the ground. However, the present invention teaches a method for using this information to identify UAS traffic to pilots of manned aircraft using existing equipment in the cockpits of most aircraft. More specifically, the invention relates to systems and methods of detecting and displaying the presence of UAS to pilots of manned aircraft using remote identification methods and using the FAA's existing system for disseminating non-participating manned traffic data to pilots and existing aircraft cockpit means for displaying traffic. Note that while the FAA currently uses the term Remote Identification to mean the transmission of several specific items using WiFi or Bluetooth protocols, the usage of that term here will be broader encompassing similar but possibly different data sets and also including additional transmission protocols.

As discussed above, most manned aircraft currently have panel mounted display systems capable of displaying other manned aircraft traffic using a system called ADS-B (In). ADS-B (In) is a complimentary function to the ADS-B (Out) system currently required by the FAA on most manned aircraft. ADS-B (Out) is a technology that broadcasts an aircraft's position, speed and altitude periodically using on-board GPS and radio broadcast transmitter. ADS-B (In) is the other side of the transmission, receiving the transmitted ADS-B (Out) signals for display to aircraft pilots. ADS-B (In) is not mandated by the FAA and its use is based on a pilot's desire for the situational awareness and safety provided by knowing where other traffic is located. While not required, ADS-B (In) receivers and displays are in wide-spread and common use today.

While ADS_B technology has been around for the better part of two decades, it is only recently (2020) that the FAA required most aircraft operating in U.S. airspace to be equipped with the technology. In the lead up to the implementation deadline, the FAA was operating a system called traffic information service-broadcast (TIS-B) to detect non-participating manned aircraft using primary airport surveillance RADAR (ASR) and then broadcast the position of these aircraft to aircraft equipped with ADS-B (In) functionality. The TIS-B system uses ASR to interrogate the transponder on a non-participating aircraft thereby obtaining the aircraft's position and altitude. This data is then used to populate a pseudo-ADS-B message and broadcast the message on the ADS-B network. The message can then be received by aircraft with ADS-B (In) equipment and displayed as traffic on existing cockpit displays. Great situational awareness benefits would follow if the existing TIS-B system, or at least applicable parts thereof, could be used for identifying unmanned traffic.

While pilots have a keen interest in knowing the position of UAS operating in their vicinity, manned aircraft owners are very much against the levying of additional expensive equipment requirements by the FAA. Thus, it is a primary objective of the invention is to provide a means for detecting, disseminating, and displaying UAS traffic data to the pilot of manned aircraft without the need for introducing additional equipment requirements on the aircraft operator by using existing interface for ADS-B (In). The present invention utilizes the existing ADS-B (In) system for disseminating and displaying UAS traffic information based on remote ID signals, thus bypassing the need for introducing new cockpit equipment.

The present invention proposes that the FAA ground stations broadcasting the TIS-B information be modified to add the capability of listening to the UAS broadcast of remote ID data and then processing and formatting that data into ADS-B traffic messages as is currently done with non-participating manned aircraft data using ASR (RADAR). The UAS remote ID broadcasts would provide the data necessary (L/L, speed, altitude) necessary to generate an ADS-B report. Note: It has been proposed that the TIS-B system be decommissioned in favor of the ADS-B system due to the diminishing number of non-participating aircraft. This invention proposes that the TIS-B system, or relevant parts thereof, be retained at least for the purpose of broadcasting the UAS traffic data to pilots. For example, the ASR RADAR, which is not needed for the UAS traffic reports, could be decommissioned while the system software and transmitting equipment used to broadcast the traffic messages could be retained and repurposed to receive the UAS RID position reports for broadcast in traffic messages. Obviously modifications and additions would be necessary to provide the equipment necessary for receiving the remote ID broadcasts as well as some software modifications to process the remote ID data and place it in ADS-B messages for transmission.

Of course the first step of the implementation is to get the UAS remote identification data to the FAA ground station. Depending on a variety of implementation details such as transmission protocol, transmit power, the range from the station, and the like, a variety of techniques may be used. As mentioned, for the FAA's remote ID rule (14 CFR § 89) WiFi Beacon and Bluetooth 5 extended advertising are the approved transmission protocols (see ASTM-F3586-22). However, although the scope of the present invention includes these protocols, it also includes numerous others such as V/UHF, LTE/cellular and satellite. Thus, several implementations are envisioned, differentiated by the communication protocol and the path the signal takes from the UAS to the FAA ground station. As was noted above, the various implementations are not necessarily mutually exclusive and may be implemented in various combinations. It is also understood that the particulars of the RF interfaces may change with changing technology and changing regulations while still implementing the design objectives of the invention.

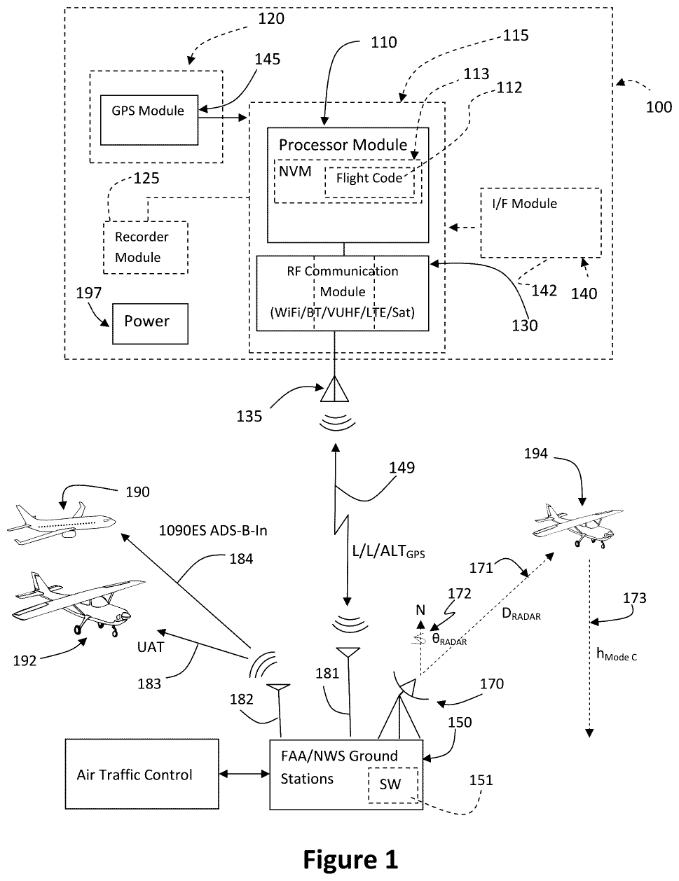

The Remote ID/UAS traffic system of the present invention discloses several communication modes: RF direct, RF relay, LTE/cellular, Satellite and various subcombinations. The communication modes are illustrated in FIGS. 1-5. The intent of the invention is to provide UAS traffic information to operators of manned aircraft. An additional goal is to provide the UAS traffic using existing aircraft receiver/display equipment and associated TIS-B/ADS-B (In) messaging structure as applicable, thereby eliminating the need for the purchase of additional equipment on the part of the aircraft owner. These goals will be achieved by using the existing FAA Traffic Information Service-Broadcast/Automatic Dependant Surveillance-Broadcast (In) (TIS-B/ADS-B (In)) system to relay the UAS position data to the manned aircraft pilots. To implement this, the FAA ground station systems would be modified to receive the UAS remote ID data and repackage the data into an ADS-B compatible message format similar to what is currently done for the non-participating equipped aircraft. This repackaged data would then be transmitted to manned aircraft as displayed on ADS-B (In) display systems as is done with the TIS-B/ADS-B (In) system today.

As mentioned, the current TIS-B system relies on a RADAR contact and a Mode-C altitude output for the traffic data transmitted to ADS-B (In) equipped aircraft for the traffic alerting system. This method would not work for small UAS as they do not carry transponders and they are generally too small to create a RADAR signature. However, the remote ID broadcast includes the position and altitude information directly that is necessary to populate the TIS-B/ADS-B (In) message, thereby substituting for the RADAR and Mode C data.

One issue requiring consideration is the range of the remote ID signal. Currently the FAA is requiring a WiFi beacon or Bluetooth 5 extended advertising signal for rule compliance. Neither of these come anywhere close to the range of a Mode-C transponder signal at altitude, nor the reach of an FAA RADAR signal. Two options appear, one utilize a signal with greater range such as V/UHF, satellite, or cellular/LTE or utilize ground stations for relay of the UAS signal, or a combination of these. The following figures and their descriptions explore these possibilities.

In the RF direct mode (FIG. 1), the UAS remote identification data (RIDD) is broadcast from the UAS airborne sensor suite/communication module (SSCM) 100 associated with a UA, directly to a FAA ground station 150 via one or more RF communication protocol(s) 149. The SSCM 100 may be either integrated with the UAS (standard remote ID) or an add-on module (Broadcast module remote ID). As mentioned above, the FAA currently requires the RF protocol to be either WiFi beacon or Bluetooth 5 extended advertising (BT5 EA). Implementation of the present invention might also include using a V/UHF signal, such as LoRa or similar, in the RF direct mode. This could be in addition to the currently approved transmission WiFi and BT5 EA methods. Clearly the FAA ground station 150 would need to have the capability to receive the WiFi, BT5 EA, and/or V/UHF transmissions. This would likely be a modification to the current set-up as the TIS-B system relies on RADAR 170 returns D_{RADAR} 171, θ_{RADAR} 172 and Mode C interrogation h_{Mode C} 173 for position determination, instead of reception of a radio signal from the UA. Additionally, ground station software 151 would need to be modified to extract the UAS position/altitude data from the remote ID message and format it into an ADS-B message for re-broadcast transmission 184, 183 in the TIS-B/ADS-B (In) system.

As mentioned above, one reason the FAA disfavored use of ADS-B on UAS directly was the concern over saturation of the frequency due to numerous UAS transmitters. If this concern extended to implementation of the present invention, it could be addressed in the limiting the transmission of UAS traffic reports 184, 183 based on UAS altitude, reasoning that only UAS above a certain height would be a concern to manned aircraft.

Communication module 130 of SSCM 100 includes the transmitter(s) which broadcasts 149 the remote ID data to the FAA ground station 150. The FAA ground station 150 then formats the UAS position data from the remote ID message into an ADS-B message and re-broadcasts the UASUAS traffic information to manned aircraft 190 and 192 via the ADS-B system e.g. UAT 183 and/or 1090ES 184 functionality.

Currently, the FAA has mandated that the RID system transmit several pieces of UAS flight and take-off data. The transmitted UAS flight data includes UAS position (latitude/longitude), altitude, speed, and fix time. Also the UAS take-off position (latitude/longitude) and altitude are to be transmitted. Finally, a unique UAS ID is to be transmitted. The position data is required to be sourced from a GPS receiver. All data is to be transmitted at a 1 Hz rate with a latency of no more than 1 second. The current position data (latitude, longitude, altitude) and ID, transmitted under the remote ID rules could be used to support the traffic awareness function of the present invention. As mentioned, additional data to that required by the FAA for remote ID could be added to enhance the UAS traffic function such as heading, ground track, vertical speed and the like.

The sensor suite/communication module (SSCM) 100 includes the sensor(s), processor, and communication components necessary to acquire, process, and transmit the UAS remote ID data. To accomplish that, the SSCM 100 includes a GPS sensor 145 for acquiring the position, altitude, and speed data required, a processor module 110 for receiving the GPS data and associated processing and control functions, and a communication module 130 for communicating the UAS remote ID data. The SSCM 100 may also include an optional recorder module 125 for storing the remote ID data and an optional user interface module 140.

The communication module 130 is the subsystem component which wirelessly transmits the RID data. In the RF direct implementation of FIG. 1, the communication module 130 is an RF transmitter such as WiFi, Bluetooth, V/UHF, or the like. The communication modes are not mutually exclusive and the communication module 130 may comprise one or more of these modes. In the RF direct mode, the communication module 130 transmits the RID data 149 from the SSCM 100 directly to the FAA ground station 150. As mentioned, the FAA ground station 150, as modified, would receive and decode the incoming remote ID message extracting data such as the UAS L/L, altitude, and ID. The ground station software 151 would then construct and ADS-B format message populated with the UAS position, altitude, and ID data and transmit (re-broadcast) the message 183, 184.

Processor 110 controls the flow of data in the system as well as initialization of sensors, and integrating all major components of the system. The processor 110 and the communication module 130 may be combined into a single integrated component such as a System on a Chip (SoC) 115. In an exemplary WiFi/Bluetooth embodiment of the implementation, the ESPRESSIF ESP-32 WiFi module is used. This module not only provides WiFi/Bluetooth functionality which may be used to wirelessly communicate remote ID data to the remote receiver/display device (RRDD), but also includes an Xtensa dual core 32-bit processor, memory, and a multitude of I/O interfaces. The multi-functionality of the ESP32 allows the processor side of the system to be utilized, even if the WiFi/BT functionality is not used. For example, in another exemplary implementation of the RF direct mode, a V/UHF transmitter, for example an RFM69 LoRa transceiver module, is used while still utilizing the ESP32 for the processor functions. The processor side of the module 115 includes non-volatile memory (NVM) 113 into which the software flight code 112 may be loaded.

Processor operations are directed by execution of flight code 112. In order to provide secure operation, flight code 112 may be factory preloaded. Processor 110 interfaces to communication module 130 and sensor suite 120, including at least GPS sensor 145. Processor 110 may also optionally be interfaced to recorder module 125 and user interface module 140. In an exemplary embodiment, the flight code 112 causes the processor 110 to periodically sample or ‘read’ data from the GPS 145. Upon receipt of sensor data from the GPS 145, the processor module 110 may perform certain processing of the data prescribed by the flight code 112. Data processing may include monitoring for alert and warning conditions such as data validity. Additionally, initialization programming processes may be controlled by processor module 110 based in part on pre-flight initialization parameters. Examples include setting transmit power and frequency, setting credentials, and the like, used to transmit the RID data to the FAA ground re-broadcast station 150. Additionally, certain GPS modules 145, such as the exemplary u-blox models implemented in the present invention, allow user selectable data output formats and rates. The values setting these initialization parameters may be constants in the flight code 112, or may be obtained from user interface 140. Coupling of the GPS module 145, interface module 140, optional recorder module 125, and processor module 110/SoC module 115 may be by standard interfacing protocols such as I2C, SPI, UART (serial) or the like. Specific choice will be driven by the components selected for the implementation.

Processor 110/SoC module 115 may also be interfaced to a user interface module 140. The user interface module 140 could include functions such as a weight-on-wheels (WOW) sensor 142, used to determine if the UAS is on the ground or in the air. The WOW module may be a physical ‘hard’ switch or a virtual ‘soft’ switch. The user interface module 140 may also include one or more visual indicators. For example, a light emitting diode (LED) might be used to indicate that the SSCM 100 is performing properly or that a certain point in the software is being executed. For example, the processor 110, executing flight code 112, might be instructed to ‘flash’ the LED at a predetermined execution point, thereby giving a visual indication of proper operation to the operator. The user interface may include a means for selecting WiFi channel, power output, communication operating modes (WiFi, Bluetooth (BT), V/UHF, or any combination), initialization altitude, and the like.

The user interface module 140 may include a means for easy download of recorded remote ID data. In one embodiment, the SSCM 100 may include a connector such as a USB connector such that the SSCM 100 may be ‘plugged’ into a computer to read/download the contents of the recorder module 125.

The SSCM 100 may also comprise non-volatile memory (NVM) (a.k.a. non-transitory storage media) 113. The non-volatile memory 113 could be a discrete module in the SSCM 100, or it could be integrated into the processor module 110/SoC module 115. The non-volatile memory 113 may store initialization parameters, remote ID data, or the like. The memory 113 may also store computer flight code or instructions 112. In an exemplary implementation, the non-transitory storage media 113 is part of the processor/WiFi module 115 and is used to store UAS take-off position, as well as the software instruction code 112. The NVM may also be referred to sometimes as a non-transitory storage medium for computer software.

The sensor module(s) 120 represent the hardware, circuitry and processing necessary to measure UAS remote ID data such as position, speed, altitude, attitude, acceleration, heading, ground track and other data. The FAA has specified that the position, altitude, and speed data is to be sourced from a GPS sensor. Thus, in the exemplary embodiment, the sensor suite includes at least a Global Positioning System (GPS) 145 to acquire vehicle position and other navigational information such as altitude and speed. There are many commercial off-the shelf (COTS) GPS sensors on the market. Some GPS module manufacturers are u-blox, Trimble, Sierra Wireless, ADH-tech, and Broadcom, to name just a few. There are also manufactures which integrate a GPS receiver and a microcontroller such as Qualcomm and STMicroelectronics. These GPSs may have interfaces such as serial, I²C, and SPI. They may output their GPS solutions using, proprietary or non-proprietary (open) formats such as the NMEA format. All output their navigation solutions at a rate of at least 1 Hz. In an exemplary embodiment, a u-blox GPS sensor utilizes an I²C interface to the processor 110/SoC module 115. Although GPS is the primary sensor, additional sensors may be added for additional or complementary data such as an Inertial Measurement Unit (IMU), an accelerometer, barometric pressure sensors, magnetometer, or even an additional GPS sensor for redundancy checking. These additional (secondary) sensors may be used to ‘check’ the performance of the primary sensor or to add additional data to the collection of flight data.

Regardless of the communication module realization, transmission of the UAS data will generally require an antenna. In FIG. 1 it is seen that the communication module(s) 130 is connected to one or more antenna 135 for broadcast of the remote ID data. In some embodiments, this may be a simple ¼ wavelength wire which can be placed anywhere so as not to interfere with flight operations. In other embodiments, the antenna may be integrated with the communication module itself (e.g. PCB trace antenna). In still others, the design may allow for flexibility to use either an external or integrated antenna. The ESP32 includes models which fall into each of these options. In one exemplary embodiment, the PCB trace antenna is utilized. In another exemplary embodiment, the external antenna model is utilized. V/UHF, LTE/cellular, and satellite implementations generally utilize a separate antenna. As mentioned, the communication modes are not mutually exclusive and the implementation may employ one or more of the communication protocols.

Computer software instructions 112 (‘flight code’) loaded into the non-volatile memory 113 of the SSCM processor module 110/SoC module 115 when executed, control the functioning of the remote ID broadcast module. These instructions will, among other things, control the initialization sequence, data collection, processing, and transmission of data. In an exemplary embodiment, the SSCM software instructions 112 are factory preloaded.

As part of the initialization/start-up, code 112 defines & initializes variables, defines data structures, sets-up and initializes the RF transceivers, and configures the GPS. As part of the GPS configuration, the output format and frequency may be selected.

After the module and sensors have been initialized, the code begins the position, velocity, time (PVT) initialization. As mentioned, the FAA remote identification requirements require the take-off position and altitude to be continuously transmitted as part of the RID data. This data is captured at start-up when the drone is positioned for take-off. As part of the initialization loop, the GPS sensor is continuously queried, looking at the data validity flags and fix quality indicators to determine when the data is usable. Once the data becomes valid, and stabilized, a snapshot of the take-off data is taken.

Once the take-off position has been determined, the code moves into the main loop where it continuously reads the GPS sensor 145, retrieving the required position, speed, altitude, and fix time information and packages it for transmission 149. This main loop is also referred to as the ‘flight loop’ as it is the code executing during flight. In an exemplary implementation, required data is continuously ‘read’ from the GPS receiver 145 and placed into a data structure defined at initialization.

Note that as mentioned, in an exemplary implementation, the same integrated module 115 utilized in the WiFi/BT implementation may be used regardless of whether the WiFi/BT capability is used. For example, the processor side 110 of the integrated ESP-32 module 115 may be used for processing functions with the WiFi functionality turned OFF or ON. In other embodiments, the microcontroller/processor may be realized as ATMEL ATMega328, ATMega 32U4, or ATSAMW25. Advantages of using common components are versatility by enabling configurability at the software level and also reuse of common software modules.

As mentioned, in a longer range implementation of the RF direct mode, the SSCM 100 and communication module 130, may comprise long range communication modules. In an exemplary implementation, LongRange (LoRa®) communication modules are used such as HOPERF RF which offers integrated RF modules for V/UHF communication such as the LoRa® RFM9x modules. In particular, the RFM95CW module is FCC registered as required by the FAA Remote Identification regulations. Such integrated communication module offerings provide not only a drop-in design component but also an inherited design and functional maturity. In an exemplary implementation, the LoRa® radio is implemented in packet mode with the RID data being encoded into a JSON or other parseable data array (packet). In other implementations, LTE/cellular and satellite communications are used.

As with the WiFi/BT implementation discussed above, in the V/UHF, LTE/cellular, and satellite implementations, computer flight software instructions 112 (‘flight code’) are loaded into SSCM processor module non-volatile memory (aka non-transitory storage media) 113. Processor 110/SoC module 115, executing the flight software instructions 112, allows SSCM 100 to perform the RID data acquisition and broadcast functions described above. In an exemplary embodiment, the SSCM software instructions 112 are factory preloaded.

The SSCM software 112 performs the same system and GPS sensor initialization sequences described above. In addition, the long-range V/UHF, LTE/cellular, and satellite radios may be initialized by setting radio parameters. Radio initialization parameters vary by radio but may include transmit power and frequency, modulation mode, hardware interface parameters, and for LoRa® radios spread factor, bandwidth, coding rate, and CRC enablement. In an exemplary implementation of the RF direct mode, the RID data is placed into a data structure used to populate a data array, which is then broadcast by the RF radio as a data packet.

In the RF direct implementation of FIG. 1, the RID signal(s) 149 are broadcast directly from the UAS SSCM 100 to the FAA re-broadcast ground station 150. The FAA ground station 150 would then include an antenna 181 and receiver (not shown) for receiving the RID signal. The receiver would be controlled by software (SW) 151 which would ‘read’ the remote ID transmission and extract the UAS position, altitude, and ID information. This information would then be placed in an ADS-B message for transmission. This part of the process should mirror that as is done for the TIS-B system. A transmitter (not shown) configured to transmit ADS-B messages would be connected to an antenna 182 and transmit the UAS position data via ADS-B message as is done with the non-participating aircraft 194. In summary, changes to the ground station would include adding an antenna/receiver for receiving the UAS remote ID signal, and modification of the ground station processing software to read and decode the UAS remote ID message, and build an ADS-B message with the UAS data. Guidelines/standards/requirements for ADS-B including message formats, are contained in RTCA documents 242A, 260A/B (ES), 282A/B (UAT) and 14 CFR 91.227.

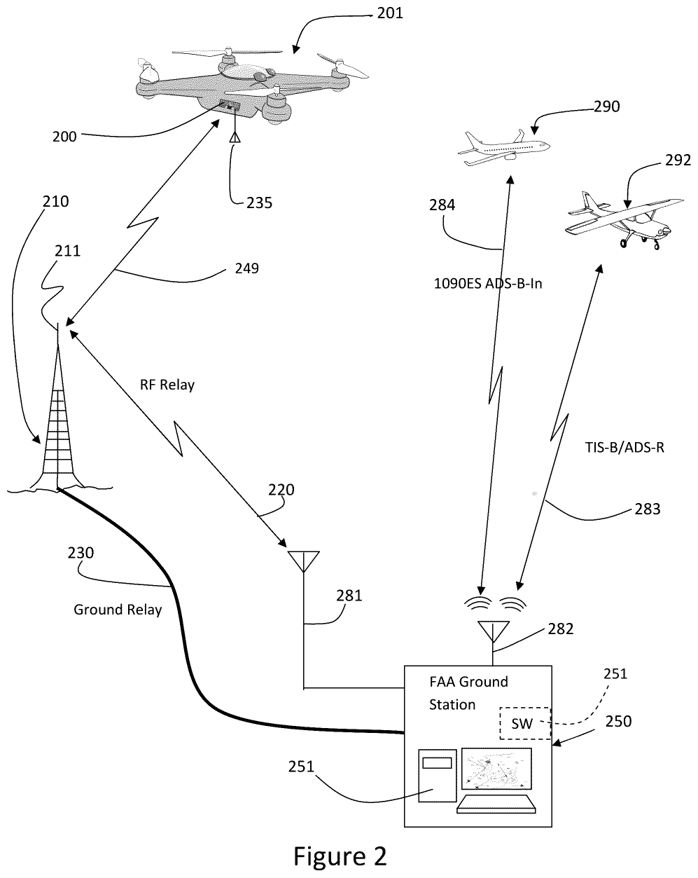

In the embodiment of FIG. 1, it is clear the UAS must be within radio range of the FAA re-broadcast ground station 150. Depending on the communication protocol used, this could be a significant limitation. To address this potential limitation, a signal relay implementation is proposed. It should be noted again that this limitation is not necessarily an alternative to the RF direct implementation of FIG. 1, but rather is complimentary, and could be implemented in conjunction with it. Furthermore, it should be noted that most of the particulars of the operation of the SSCM 100 described above in conjunction with FIG. 1 are also applicable to the relay implementation depicted in FIG. 2.

FIG. 2 illustrates the embodiment wherein an intermediary relay function occurs prior to the UAS remote ID signal(s) 249 reaching the FAA re-broadcast ground station 250. In this embodiment, the remote ID signal(s) 249, be it WiFi, Bluetooth, or V/UHF, is received by the relay station 210 and then forwarded (relayed) to the FAA re-broadcast ground station 250. It is contemplated that the relay may be by RF 220, or by some type of ground relay 230.

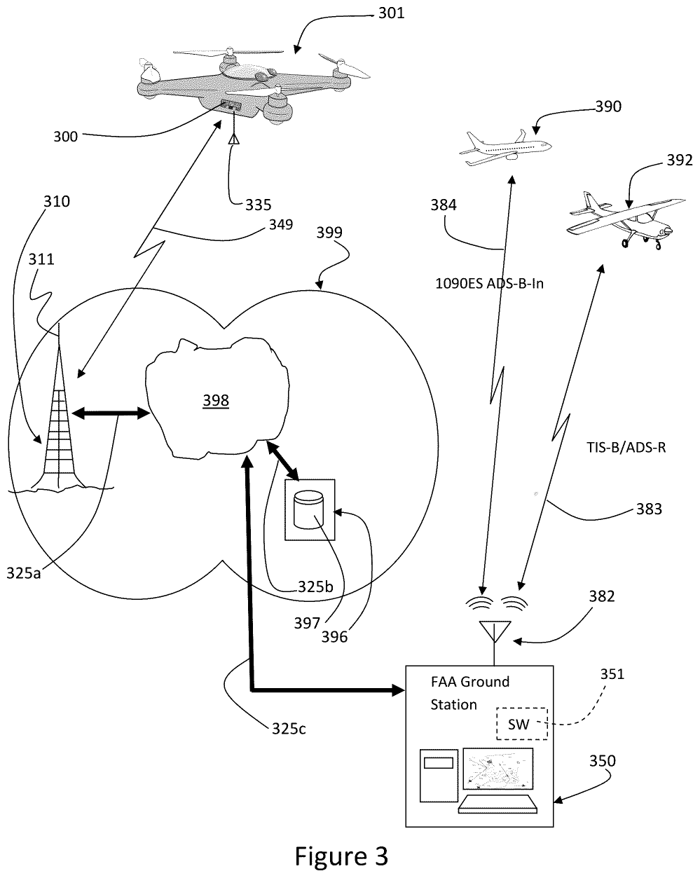

Operation of the remote ID module 200 in this implementation is nearly identical to that described in FIG. 1. The remote ID module 200 attached to UAS 201 transmits its remote ID information via one or more RF communication protocol(s) 249 (e.g. WiFi, BT, V/UHF, or the like). Remote ID module communication module 230 (not shown) would include a transmitter corresponding with the remote ID signal protocol(s) 249 and one or more antenna 235 capable of supporting that communication protocol. A relay station 210 would be within radio range of the UA. The relay station 210 would comprise an antenna 211 and associated receiving equipment (not shown) for receiving the transmitted UAS signal(s). Depending on the relay method, the relay station 210 would also include an RF transmitter for relay transmit 220 of the UAS data, or some interface circuitry for interfacing with a ground based network such as the internet (see FIG. 3) for ground relay 230 of the UAS data. The relayed remote ID signal is received by the FAA re-broadcast station 250 where the relayed UAS remote ID data is then unpacked from the relay message and placed into an ADS-B formatted message by ground station software 251, for transmission (re-broadcast) 284, 283 to aircraft 290, 292 as discussed above. Guidelines/standards/requirements for ADS-B including message formats, are contained in RTCA documents 242A, 260A/B (ES), 282A/B (UAT) and 14 CFR 91.227.

Obviously, the placement and number of relay stations 210 would depend on the transmitting power of the UAS signal(s) 249. Also the flight paths of the UAs would be a factor. For example if specific airways are designated for UAS traffic, relays stations 210 could be placed at various points along the airway. Given the enhanced need for traffic situational awareness in the vicinity of airports, it makes sense that the number and location of relay stations would be concentrated in those areas.

FIG. 3 illustrates another embodiment wherein an intermediary relay function occurs prior to the UAS remote ID signal reaching the FAA re-broadcast ground station 350. In this embodiment, the remote ID signal(s) 349 are received by the relay station 310 and then accessible to the FAA ground re-broadcast station 350. In the implementation of FIG. 3, UAS transmissions 349 could include, WiFi, BT, V/UHF, and LTE/cellular, singularly or in combination. In the FIG. 3 implementation, the relay network is contemplated to include a ground network 399 such as the internet 398.

Operation of the remote ID module 300 in this implementation is nearly identical to that described in FIG. 1. The remote ID module 300 attached to UAS 301 transmits its remote ID information via one or more RF communication protocol(s) 349 (e.g. WiFi, BT, V/UHF, LTE/cellular or the like). Remote ID module communication module 330 (not shown) would include a transmitter corresponding with the remote ID signal protocol(s) 349 and one or more antenna 335 capable of supporting that communication protocol(s). A relay station 310 would be within radio range of the UA. The relay station 310 would comprise an antenna 311 and associated receiving equipment (not shown) for receiving the transmitted UAS signal(s) 349. The relay station would also include some interface circuitry for interfacing with a ground based network 399 such as the internet 398, to provide FAA ground re-broadcast station 350 access to the UAS data. The relayed remote ID data is accessed by the FAA station 350 where the UAS remote ID data is then unpacked and placed into and ADS-B formatted message for transmission (re-broadcast) 384, 383 to aircraft 390, 392 as discussed above.

Guidelines/standards/requirements for ADS-B including message formats, are contained in RTCA documents 242A, 260A/B (ES), 282A/B (UAT) and 14 CFR 91.227.

FIG. 3 illustrates use of a long range network 310/399. In one exemplary embodiment, the transmission from the UAS 349 are V/UHF signals and the long range network 399 is comprised of a receiver 310 receiving V/UHF signals which is then connected to the internet 398 through a computer system (not shown). In another embodiment, the transmission from the UAS 349 is an LTE/cellular signal and the long range network receiver 310 is a cell site receiving the LTE/cellular signals. The LTE/cellular network 399 is connected to the internet 398. End users such as FAA air traffic ground re-broadcast station 350 may access the RID data from the database 397 by connecting to the database server 396 thru the internet 398 using conventional means 325c such as an ISP broadband connection, fiber optic, or the like. In the case of the LTE/cellular implementation, the worldwide cellular network is comprised of a multitude of cell sites 310 so a UAS would almost always be in radio range of a cell tower, especially with the transmission occurring at altitude providing a clear line of site to at least one cell tower at almost all times.

The cell sites are connected 325a to the internet 398 via standard techniques such as high speed fiber optic cable, well understood in the art. A database 397 hosted on an internet server 396, is connected 325b to the internet 398 via the server 396 so that data received by cell site 310 may be stored on the database 397. The database may be on a server managed by a government agency such as the FAA or by a government contractor. FAA re-broadcast ground station 350 could then access the received remote ID data, via an internet connection 325c, reformat it into ADS-B messages and re-broadcast the UASUAS traffic data to manned aircraft 390, 392 via ADS-B signals 383, 384.

Obviously, the placement and number of relay stations 310 would depend on the transmitting power of the UAS signal 349 and the nature of the signal 349. For example, in the case of LTE/cellular, cell tower placement decisions are made by the cell network providers. Placement decisions are made to ensure adequate coverage for ground based cell phones. Thus, coverage for airborne transmitters, with a larger transmission footprint, is fairly certain. In the case of non-cellular transmission, the flight paths of the UAs would be a factor. For example if specific airways are designated for UAS traffic, relays stations 310 could be placed at various points along the airway.

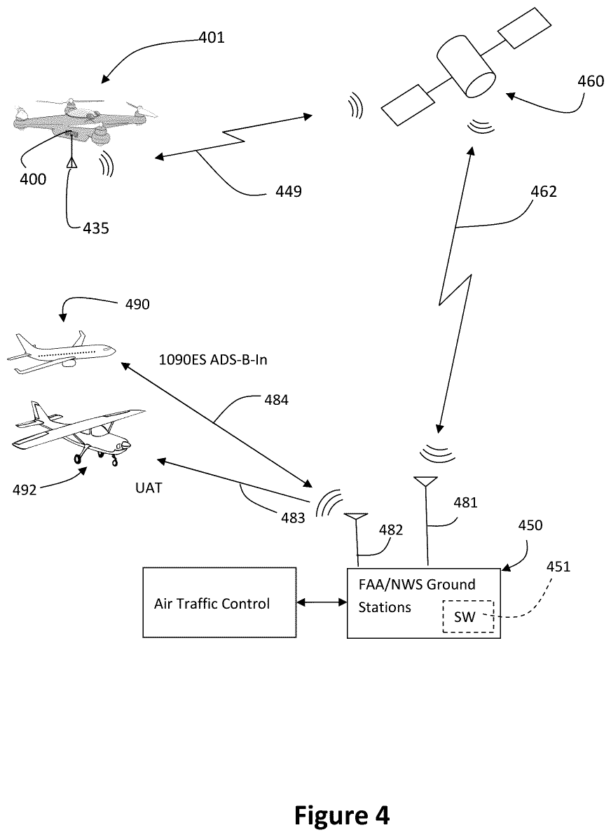

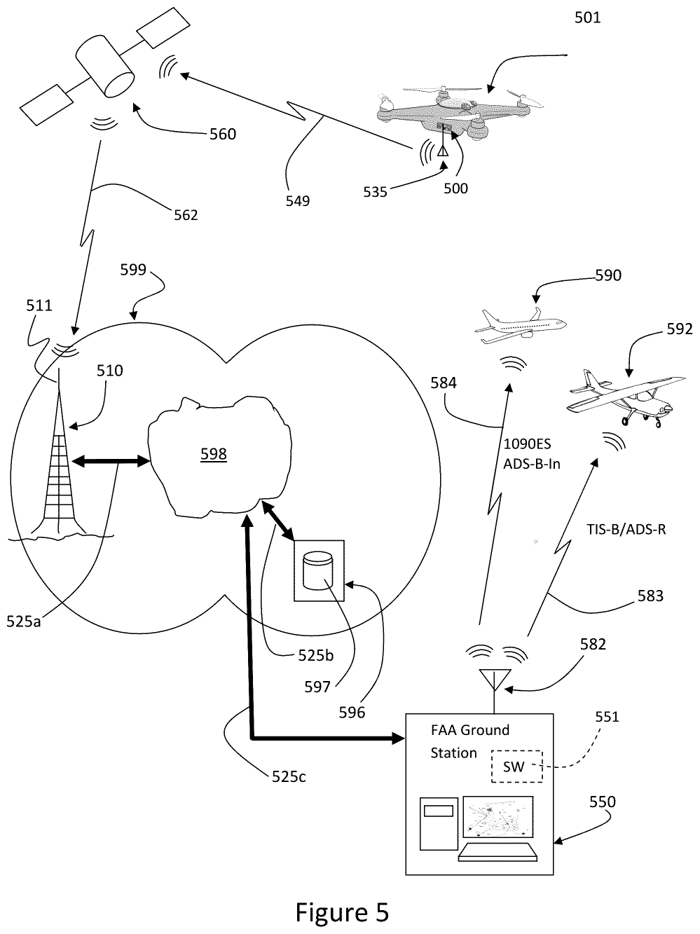

FIG. 4 illustrates another embodiment for transmitting the UAS remote ID data to the FAA re-broadcast ground station 450 using satellite communications. In this embodiment, the remote ID signal 449, is transmitted to satellite 460 which then rebroadcasts it 462 to the FAA ground station 450. In the implementation of FIG. 4, UAS remote ID transmissions 449 are implemented using satellite communications technology. The implementation of FIG. 4 applies to configurations where the FAA re-broadcast ground station 450 is able to receive the satellite broadcasts 462 directly. For configurations where the satellite data is hosted on an intermediary satellite ground station, see FIG. 5.

Operation of the remote ID module in this implementation is nearly identical to that described in FIG. 1. The remote ID module 400 attached to UAS 401 transmits its remote ID information via satellite communication protocol 449. Remote ID module communication module 430 (not shown) would include a satellite transmitter/modem corresponding with the remote ID signal protocol 449 and an antenna 435 capable of supporting satellite communications. A satellite 460 would receive the transmitted UAS remote ID signal 449. The satellite 460 would then rebroadcast (relay) the received UAS remote ID data 462 to the FAA ground station to provide FAA re-broadcast ground station 450 access to the UAS data. The transmission footprint of the satellite assures the signal would be visible to most if not all FAA ground stations operating in the CONUS. The relayed remote ID data received by the FAA station is then unpacked and placed into and ADS-B formatted message for transmission (re-broadcast) 483, 484 to participating UAT equipped aircraft 492 and 1090ES equipped aircraft 490 as discussed above.

FIG. 5 illustrates another embodiment wherein an intermediary relay function occurs prior to the UAS remote ID signal reaching the FAA re-broadcast ground station 550. This implementation is different from that of FIG. 4 in that the FAA ground station 510 is presumed to lack the capability of receiving the satellite signal 462 directly. In the embodiment of FIG. 5, the remote ID signal 549 is transmitted to a satellite 460 which then rebroadcasts or downlinks the remote ID data to a satellite ground station 510. The satellite ground station is connected to a ground network 599 which is accessible to the FAA re-broadcast ground station 550. In the FIG. 5 implementation, the ground relay network 599 may include the internet 598.

Operation of the remote ID module in this implementation is nearly identical to that described in FIG. 1. The remote ID module 500 attached to UAS 501 transmits its remote ID information via an RF communication protocol 549 (i.e. satellite). Remote ID module communication module 530 (not shown) would include a satellite transmitter corresponding with the remote ID signal protocol 549 and an antenna 535 capable of supporting satellite communications. The satellite ground station 510 would be within radio reception range of the satellite 560 transmissions 562. The satellite ground station 510 would comprise an antenna 511 and associated receiving equipment (not shown) for receiving the transmitted UAS remote ID signal 549 transmitted from satellite 560. The satellite ground station 510 would also include some interface circuitry for interfacing with a ground based network 599 such as the internet 598, to provide FAA re-broadcast ground station 550 access to the UAS remote ID data. The relayed remote ID data is accessed by the FAA re-broadcast station 550 via high speed connection 525c such as fiber optic cable, where the UAS remote ID data is then unpacked and placed into and ADS-B formatted message for transmission (re-broadcast) 584, 583 to aircraft 590, 592 as discussed above.

FIG. 5 illustrates use of satellite long range network comprising satellite 560 and satellite relay/ground station/network 510/599. In one exemplary embodiment, the transmission from the UAS 549 are satellite signals and the long range network 599 is comprised of a ground station/receiver 510 receiving the satellite signals which is then connected to the internet 598 through a computer system (not shown). End users such as FAA air traffic re-broadcast ground station 550 may access the RID data from the database 597 by connecting to the database server 596 thru the internet 598 using conventional means 525c such as an ISP broadband, fiber optic connection or the like.

The satellite relay/ground station/network 510/599 is connected 525a to the internet 598 via standard techniques well understood in the art. A database 597 hosted on an internet server 596, is connected 525b to the internet 598 via the server 596 so that data received by satellite relay/ground station/network 510/599 may be stored on the database 597. The database may be on a server managed by a satellite provider, government agency such as the FAA, or by a government contractor. FAA re-broadcast ground station 550 could then access the received remote ID data, via internet connection 525c, reformat it into ADS-B messages and re-broadcast the UAS traffic data to manned aircraft 590, 592 via ADS-B signals 583 584.

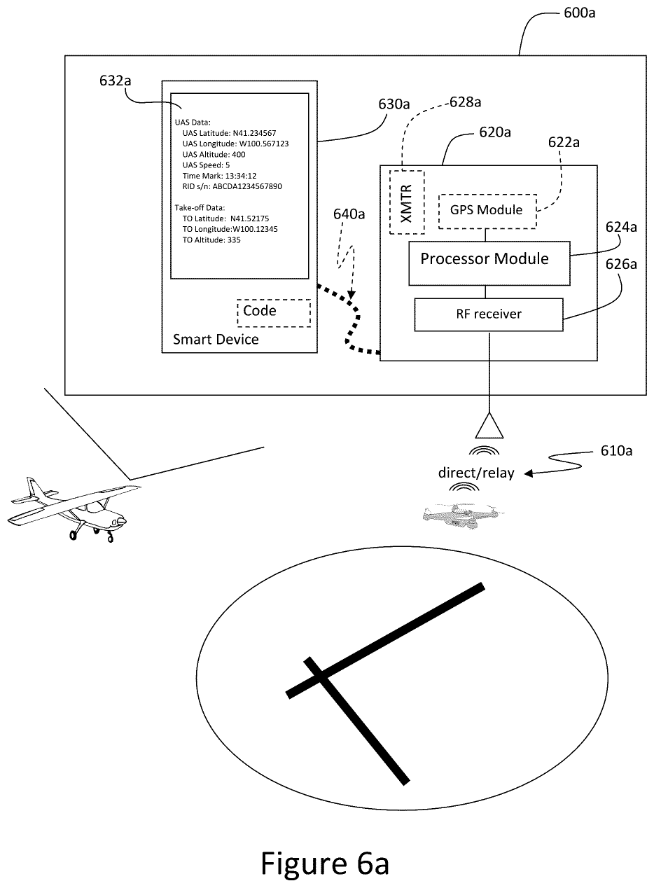

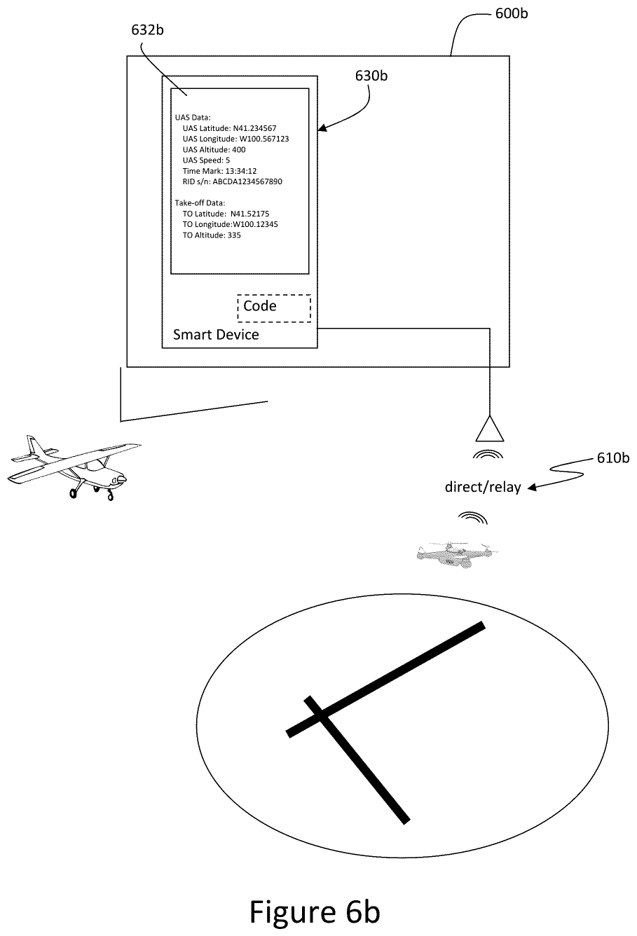

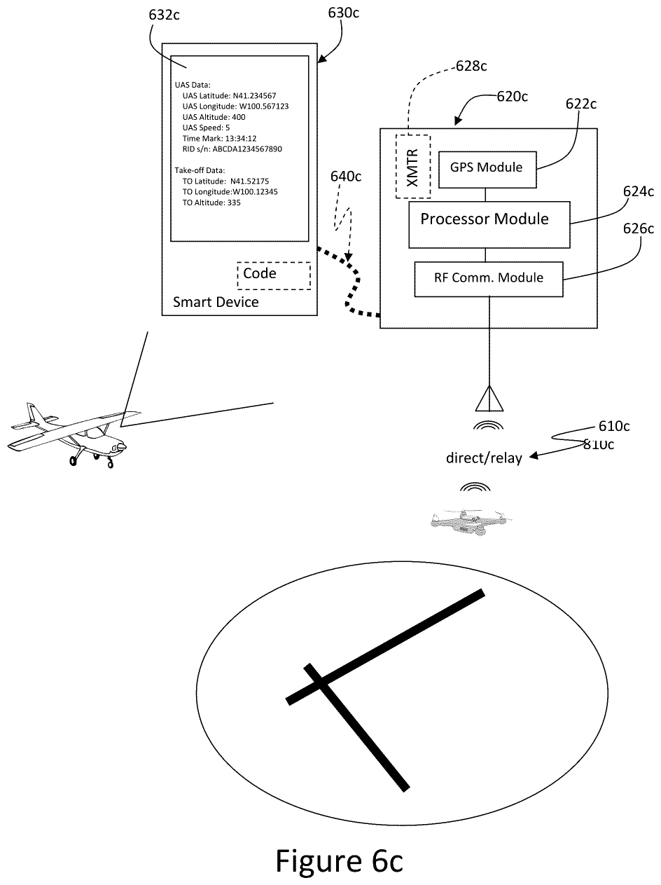

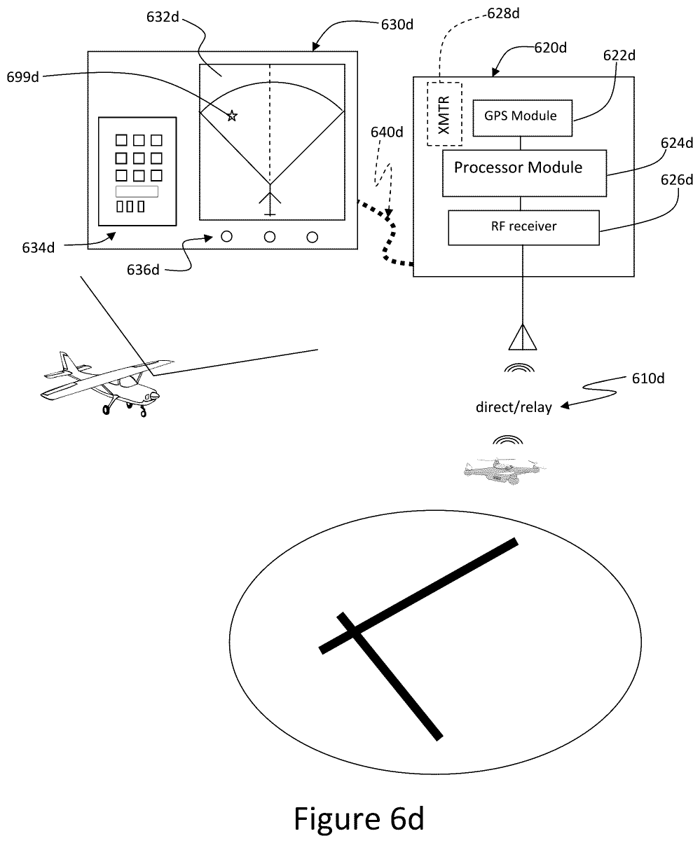

FIGS. 6a-6d illustrate various implementations of the cockpit receiver/display system (CRDS). FIG. 6a illustrates the WiFi/BT/VUHF UAS RID transmission where the remote identification data is transmitted from the UAS to end users such as the cockpit receiver/display system (CRDS) 600a using V/UHF, WiFi or Bluetooth technology 610a. Conceptually, there are two main components to the CRDS, the receiver 620a and the display 630a although in some implementations the receiver and display may be the same device (see FIG. 6b implementation). The receiver module 620a and display 630a may be connected using a wired or wireless connection 640a. The receiver module 620a will likely comprise at least three elements: a communication module 626a; a processor 624a; and possibly a GPS 622a. The cockpit display 630a would be comprised of a display screen 632a and some sort a user interface of some sort for selecting various display control parameters such as display mode, range, various display filters and the like. Depending on the display implementation, the user interface may comprise a ‘soft’ keyboard such as in the case of a smart device (FIG. 6a) or an entry pad 634d and perhaps some selector knobs in panel mount display device (FIG. 6d). Optional GPS receiver 622a provides a means for obtaining the position of the manned aircraft so that the relative position and distance between the manned aircraft and the UAS can be determined. This is necessary if plotting the relative positions of the two vehicles on the display 630a and if generating collision avoidance alerts. The processor module 624a executes software implementing the receiver functionalities including receiving the transmitted UAS data 610a, processing the data for display parameters such as relative vertical and horizontal distances, closure rates, UAS RID data, and the like. Communication module 626a receives the signal 610a transmitted from the UAS. Thus, its receiver tuner must be set to the frequency of the UAS transmitter, e.g. V/UHF, WiFi, Bluetooth, cellular, satellite, and the like. Optional transmitter 628a provides wireless connection functionality of the receiver module 620a and display 630a are connected wirelessly. The operating protocol of transmitter 628a is determined by the wireless functionality of display 630a. For example, if display 630a is a smartphone, these generally have WiFi and Bluetooth wireless capability. In that case, transmitter 628a may be WiFi or Bluetooth capable.

FIG. 6b illustrates another embodiment where the UAS RID transmission is also transmitted from the UAS to end users such as the cockpit receiver/display system (CRDS) 600b using WiFi or Bluetooth technology 610b, but where the broadcast is directly to the display system 630b, i.e. without an intermediate receiver. This is possible because the display system 630b is capable of receiving the UAS broadcast directly since it has a WiFi/BT receiver integrated within the smart device 630b. Since there is no external GPS in this implementation, the smartphone location information would be used for relative positioning computations, with the smartphone processor performing all calculations.

FIG. 6c illustrates another embodiment similar to FIG. 6a except where the UAS RID transmission is transmitted from the UAS to end users such as the cockpit receiver/display system (CRDS) 600c using V/UHF technology 610c. As above, optional transmitter 628c provides wireless connection functionality of the receiver module 620c, and display 630c, are connected wirelessly. The operating protocol of transmitter 628c is determined by the wireless functionality of display 630c. For example, if display 630a is a smartphone, these generally have WiFi and Bluetooth wireless capability. In that case, transmitter 628a may be WiFi or Bluetooth capable.

FIG. 6d is similar to implementation of FIG. 6c except that the display unit 630d is more a fixed display such as is seen with so called panel mount displays. The receiver module 620d and display unit 630d may be connected using a wired or wireless connection 640d. In this implementation, the receiver module 620d is a discrete component, it likely comprises at least three elements the receiver 626d, a processor 624d, and possibly a GPS 622d. The cockpit display unit 630d would be comprised of a display screen 632d and some sort a user interface of some sort for selecting various display control parameters such as display mode, range, various display filters and the like. The user interface may comprise an entry pad 634d and perhaps some selector knobs 636d in panel mount display device (FIG. 6d). Optional GPS receiver 622d provides a means for obtaining the position of the manned aircraft so that the relative distance between the manned aircraft and the UAS can be determined. This is necessary if plotting the relative positions of the two vehicles and if generating collision avoidance alerts. The processor module 624d executed receiver software implementing the receiver functionalities including receiving the transmitted UAS data 610d, processing the data for display parameters such as relative vertical and horizontal distances, closure rates, UAS RID data, and the like. Receiver 626d is of course the component receiving the signal 610d transmitted from the UAS. Thus, its receiver will be tuned to that of the UAS transmitter, e.g. WiFi, Bluetooth, V/UHF, cellular, satellite, and the like. Optional transmitter 628d provides wireless connection functionality of the receiver 620d and display 630d are connected wirelessly. The operating protocol of transmitter 628d is determined by the wireless functionality of display 630d. For example, if display 630d is a smartphone, these generally have WiFi and Bluetooth wireless capability. In that case, transmitter 628d may be WiFi or Bluetooth capable. The display area 632d may contain textual data, graphical data or a combination of both. In an exemplary implementation, the display may include a Plan Position Indicator (PPI) format display with individual UAS 699b being displayed in relation to relative position of the UAS and the manned aircraft per distance and azimuth. Vertical data may also be shown such as the relative difference in altitudes of the UAS and the manned aircraft. Also as mentioned above, the UAS data and sensed manned aircraft data may be used to generate collision avoidance alerts. Note also that as an alternative to the dedicated display as shown in FIG. 6d, another display option is to provide the UAS data as an overlay to other display formats such as a flight plan display using an existing aircraft display system.

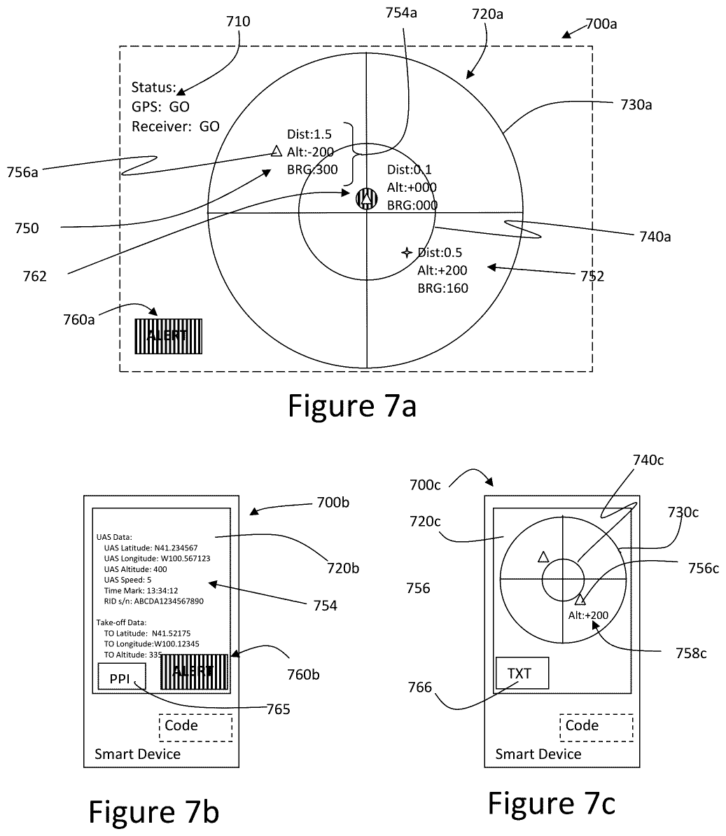

FIG. 7a illustrates one example of how a PPI cockpit display 700a might look. The cockpit display 700a might include a status indicator 710 indicating the status of the system and various components thereof. The PPI cockpit display 720a may comprise an outer ring 730a indicating the range limits of the cockpit display and one or more range rings 740a indicating some intermediate range. Each received UAS signal 750, and manned aircraft 752, would be displayed on the PPI 720a. In an exemplary embodiment, the displayed data block 750 would include a textual listing of data 754a and a UAS symbol 756a indicating the relative position of the UAS bases on its transmitted data and the position of the manned aircraft. In an exemplary implementation, alerts are provided if traffic is detected with collision range. In one implementation, a textual alert is provided within the display field 762 along with a position specific pictorial alert showing the relative positions of the two vehicles 760a.

In addition to a panel mount cockpit display, the invention is also contemplated to be used with a portable cockpit display such as a smartphone. FIG. 7b illustrates one example of an implementation with one such portable cockpit display. The cockpit display 700b might include the PPI format display as illustrated in FIG. 7a or a textual display 754 as indicated in FIG. 7b. In one implementation, each received UAS signal would be designated a separate page for display of the received data. In an exemplary implementation, alerts are provided if traffic is detected with collision range. In one implementation, a textual alert is provided within the display field 720b. Another feature of this implementation might be a button 765 allowing a quick transition from the textual display of FIG. 7b to the PPI display of FIG. 7c.

FIG. 7c illustrates another example of an implementation with one such portable cockpit display. The cockpit display 700c illustrates the PPI format display on a smart device such as a smartphone. Similar to what was shown in FIG. 7a. The PPI cockpit display 720c may comprise an outer ring 730c indicating the range limits of the display and one or more range rings 740c indicating some intermediate range. Each received UAS signal would be displayed on the PPI 720c. In an exemplary embodiment, the displayed data block 758c may include a textual listing of data and a UAS symbol 756c indicating the relative position of the UAS bases on its transmitted data and the position of the manned aircraft. Obviously the display area of a smartphone FIG. 7c is more limited than that of the panel mounted cockpit display of FIG. 7a and thus the amount of data which can be displayed is more limited. In one exemplary implementation, an altitude delta 758c is displayed. Another feature of this implementation might be a button 766 allowing a quick transition from the PPI display of FIG. 7c to the textual display of FIG. 7b.

It should be clear to those skilled in the art that the above illustrated embodiments are not mutually exclusive but rather may be employed in various combinations. For example the short range embodiment of FIG. 1 utilizing a V/UHF or BT5 transmitter to transmit directly to FAA ground stations within close proximity to the UAS flight path. Additionally, the remote ID module communication module may include a satellite or LTE/cellular transmitter for transmitting to ground relay stations directly (FIG. XX) or through a satellite relay (FIG. 5)

What is claimed is:

1. A cockpit receiver/display system (CRDS) for manned and unmanned receiving aircraft, the CRDS operative to receive broadcast UAS RID flight data, process the data, and communicate the processed data to the receiving aircraft cockpit display system for displaying the received UAS RID flight data, the receiving aircraft CRDS comprising:
a receiver/processing suite located within the receiving aircraft cockpit for receiving UAS transmitted RID data, the receiver/processing suite having,
a communication module for receiving the broadcast UAS RID flight data, the UAS RID including at least the absolute position (latitude and longitude) of the UAS,
a processor in communication with the communication module, the processor periodically sampling the received UAS RID flight data from the communication module to obtain the received UAS RID flight data, the processor processing the received RID data into a format for display presentation on the receiving aircraft display system,
a display system in communication with the processor to receive the processed UAS RID data and display the data on the display system and,
a non-transitory storage medium for storing computer software instructions executable by the processor, the execution of which causes the CRDS to receive the transmitted UAS RID data, process the received data into a display format, and display the RID data on the receiving aircraft cockpit display.

2. The cockpit receiver/display system of claim 1 wherein the UAS RID broadcast is received by the receiving aircraft directly from the UAS.

3. The cockpit receiver/display system of claim 1 wherein the UAS RID data is rebroadcast to the receiving aircraft from a rebroadcast station.

4. The cockpit receiver/display system of claim 3 wherein the re-broadcast station is an airborne station.

5. The cockpit receiver/display system of claim 3 wherein the re-broadcast station is a ground station broadcasting the FAA Traffic Information Service-Broadcasts (TIS-B) and wherein the receiver processing suite is an existing radio receiver capable of receiving TIS-B broadcasts.

6. The cockpit receiver/display system of claim 3 wherein the re-broadcast station is a ground station broadcasting the FAA Automatic Dependent Surveillance-Broadcast (ADS-B) broadcasts and wherein the receiver processing suite is an existing radio receiver capable of receiving FAA Automatic Dependent Surveillance-Broadcast (ADS-B) broadcasts.

7. The cockpit receiver/display system (CRDS) of claim 1 wherein the non-transitory storage medium for storing computer software instructions comprises instructions for the processor which when executed convert the UAS absolute position transmitted in the RID, into a position referenced to the receiving aircraft in which the UAS RID display is occurring and generates collision avoidance alerts upon condition of impending collision between the UAS and the receiving aircraft.

8. The cockpit receiver/display system of claim 4 wherein the airborne re-broadcast station is a satellite and wherein the receiving aircraft receiver suite is capable of receiving the satellite rebroadcast signal.

9. The cockpit receiver/display system of claim 1 wherein the display system further comprises a display area and a user interface, the user interface including one or more user selectable controls to control the display presentation of data on the display screen and a control which allows the display of data to be altered between a pictorial mode and a textual mode with one activation action.

10. The cockpit receiver/display system of claim 1 wherein the display system and receiver/processor suite further include a wireless communication means such that the receiver/processor suite and the display system may be connected wirelessly and display data transmitted wirelessly from the receiver/processor suite to the display system.

11. The cockpit receiver/display system of claim 1 wherein the receiver/processor suite and display system comprise a smartphone.

12. A cockpit receiver/display system (CRDS) for manned and unmanned aircraft systems (UAS) operative to receive UAS RID flight data rebroadcast by a re-broadcast station and communicate the data to a cockpit display for display of the received UAS RID flight data, the CRDS comprising:
a receiver/processing suite located within the cockpit for receiving UAS transmitted RID data, the receiver/processing suite having,
a communication module for receiving the relay broadcasts,
a processor in communication with the communication module, the processor periodically sampling the received UAS RID broadcasts and extracting the RID flight data therefrom and processing the extracted RID data into a format for presentation,
a display system in communication with the processor to receive the processed UAS RID data and display the data on the display system and,
a non-transitory storage medium for storing computer software instructions executable by the processor, the execution of which causes the CDS to receive the transmitted UAS RID data, process the received data into a display format, and display the RID data on the cockpit display.

13. The system of claim 12 wherein the re-broadcast station is an FAA TIS-B or ADS-B broadcast station and wherein the rebroadcast of the UAS RID data display is accomplished using the FAA's Traffic Information Service-Broadcast (TIS-B) or Automatic Dependent Surveillance-Broadcast (ADS-B).

14. The system of claim 13 wherein the receiver processing suite is an existing radio receiver capable of receiving TIS-B or ADS-B (In) broadcasts.

15. A method of receiving a broadcast of UAS RID data in manned or unmanned aircraft for the purpose of situational awareness display and/or alerting as to potential collision conditions, the method including,
providing a receiver system onboard the receiving aircraft capable of receiving the UAS RID broadcast, the receiver system having at least a processor and display interface,
receiving the broadcast UAS RID signals,
processing the received UAS RID signal to extract the UAS RID,
communicating the extracted UAS RID data to the display system interface and,
displaying the extracted UAS RID data on the display system.

16. The method of claim 15 wherein the UAS RID data is received by a re-broadcast station and is rebroadcast to the receiving aircraft from the re-broadcast station.

17. The method of claim 16 wherein the re-broadcast station is an airborne station.

18. The method of claim 16 wherein the re-broadcast station is a ground station broadcasting the FAA Traffic Information Service-Broadcasts (TIS-B) and wherein the UAS RID data received by the ground station is rebroadcast as TIS-B broadcast messages and wherein the receiver processing suite is an existing radio receiver capable of receiving TIS-B broadcast messages.

19. The method of claim 16 wherein the re-broadcast station is a ground station broadcasting the FAA Automatic Dependent Surveillance-Broadcast (ADS-B) broadcasts) and wherein the UAS RID data received by the ground station is rebroadcast as ADS-B broadcast messages and wherein the receiver processing suite is an existing radio receiver capable of receiving FAA Automatic Dependent Surveillance-Broadcast (ADS-B) broadcast messages.

20. The method of claim 17 wherein the airborne re-broadcast station is a satellite) and wherein the UAS RID data received by the satellite is rebroadcast as satellite broadcast messages and wherein the receiving aircraft receiver suite is capable of receiving the satellite rebroadcast messages.
